(19) United States
(12) Patent Application Publication
(10) Pub. No.: US 2009/0091070 A1
(43) Pub. Date: Apr. 9, 2009

(54) Torsion vibration damper

(75) Inventors: Bruno Mueller, Sasbach (DE); Parviz Movlazada, Buehlertal (DE)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 12/283,230

(22) Filed: Sep. 10, 2008

(30) Foreign Application Priority Data
Oct. 9, 2007 (DE) 10 2007 043 101.7

(51) Int. Cl. F16F 1/10

(52) U.S. Cl. 267/157

(57) ABSTRACT

A torsion vibration damper for a drive train is proposed, including two flange components, forming an input component and an output component, rotatable within limits relative to one another about a common axis of rotation against the effect of at least one energy accumulator, such that the at least one energy accumulator is supported against centrifugal force effects by at least one support element, which is supported radially inside the at least one energy accumulator, wherein the at least one support element is supported rotatable about a rotation axis relative to the flange components.

### FIELD OF THE INVENTION

The invention relates to a torsion vibration damper for a drive train, comprising flange components, rotatable within limits relative to one another about a common axis of rotation against the effect of at least one energy accumulator, wherein the at least one energy accumulator is supported against the effects of centrifugal forces by at least one support element, which is supported radially within the at least one energy accumulator.

### BACKGROUND OF THE INVENTION

Torsion vibration dampers are known in drive trains for dampening inconsistencies in the rotation of combustion engines used as drive units. Thus, between an input side of the torsion vibration damper from the combustion engine and an output side towards the transmission, two flange components are rotated relative to one another against the effect of energy accumulators, like e.g. compression springs. When torque spikes of the combustion engine occur, energy is absorbed by the energy accumulator, and released back to the drive train, when the torque is reduced. With increasing speed of the combustion engine, and of the torsion vibration damper, rotating about the same axis of rotation, the energy accumulators mostly disposed in circumferential direction of the torsion vibration damper are accelerated to the radial outside. This leads to an increased friction of the energy accumulator at outer surfaces of the torsion vibration damper or to an increased radial loading of the energy accumulators by centrifugal force effects, if said energy accumulators cannot be supported at respective outer surfaces.

As a protection against negative effects of the centrifugal forces, so-called slider dishes or slider shoes are used at the outside of the energy accumulators. It is furthermore suggested to support the energy accumulators on the radial outside by respective support elements, reaching around the energy accumulators, wherein said support elements are supported at inner components of the torsion vibration damper.

### SUMMARY OF THE INVENTION

It is the object of the present invention to improve torsion vibration dampers in an advantageous manner. In particular, the properties of torsion vibration dampers with respect to their behavior relative to centrifugal force effects shall be improved.

The object is accomplished by a torsion vibration damper for a drive train, comprising two flange components, rotatable within limits, as an input component and an output component about a common axis of rotation against the effect of at least one energy accumulator, wherein the at least one energy accumulator is supported against centrifugal force effects by means of at least one support element, which his radially supported within the at least one energy accumulator, and the at least one support element is rotatably supported about the axis of rotation relative to the flange components. Thus, the two flange components can be supported on one another or they can be jointly supported on a hub, wherein one flange component can be rotatable and the other can be fixated, and thus, an in-feed or an out-feed of the torque transferred into the torsion vibration damper can be performed through the hub, e.g. through an interior teething. The flange components can be formed from forged components, which are machined, and/or from sheet metal components, which are fabricated in a one-step stamping process, which are manufactured by respective sheet metal working methods known to those having skill in the art. The remaining flange type components can also be fabricated according to one of said methods.

The flange components can comprise respective moldings or embossing for loading the at least one energy accumulator and/or for forming an interlock for additional driving or driven components of the drive train. The limited rotation angle of the two flange components can be provided in one respective direction of rotation by soft or hard stops, like e.g. rubber stops or metallic stops at the respective flange component or at components provided for this purpose. Alternatively, energy accumulators going into blockage can be used as stops. A slipping clutch can be used between the flange components.

The rotation axis is defined as the rotation axis of the torsion vibration damper about itself. The rotation axis can be identical to the rotation axis of the crank shaft of a combustion engine, besides possible axial offsets or relative angles between the axes. The torsion vibration damper can be received in a drive train on the crankshaft side or on the transmission side. In particularly heavy embodiments, the torsion vibration damper can be received rotatably in a support component, wherein the support component is fixated at a housing component.

The at least one energy accumulator can be comprised of plural particular coil springs, which are combined in groups and distributed about the circumference on a certain diameter. Furthermore, additional groups of coil springs can be disposed on another diameter, wherein they can comprise identical spring constants or different spring constants, and contact the loading surfaces of input and output components at the same rotation angle or at different rotation angles relative to the other springs, which determines the effect of each particular spring, so that they form a multistage spring characteristic. In particular, on the outer diameter of the energy accumulators to be disposed, so-called arc springs can be provided, which are pre-bent to the installation diameter already before assembly, and which cover an angle of approximately 180° when using two arc springs, so that they cover the entire circumference, only leaving the flanges open, which are loading them. When using three arc springs, said angle advantageously comprises approximately 120°. When using springs, which are short compared to the arc springs, depending on the length and the diameter, on which the coil springs are disposed, four to eight coil springs, in special cases only three, preferably four to eight coils springs can be disposed. These can be disposed in order to obtain a soft spring unit with low stiffness, analogous to a loading of arc springs, so that the loading surfaces loading the spring units load a respective group of coils springs at the two end sides of said spring group, wherein the ends, located there between, of the respectively adjacent springs are connected by a support component and radially supported. The coil springs can be loaded in tension- or compression direction; preferably they are used as compression coil springs. The spring groups can be connected in series or in parallel amongst one another. Arc- and short coil spring groups can be combined amongst one another.

A friction device can be associated in parallel or in series with at least one group of springs. Respective free angles without friction can be provided.

The at least one support element can be formed from plural support elements, distributed about the circumference of the energy accumulators, or can be formed at their joining ends by short coil springs. It can be formed from sheet metal or plastic and radially envelopes the energy accumulators to be protected against the effects of centrifugal forces, so that the centrifugal force is supported on the radial inside of the energy accumulators at a component of the torsion vibration damper. Said component can be a flange component acting as input component or output component, or it can be a hub, on which both flange components or at least one of the flange components are disposed. The respective component thus has suitable receivers. Thus, circular segment shaped recesses or openings can be provided in the component, in which one or plural support components are received, so that the support components can rotate in the direction of the supported energy accumulators about the rotation axis during a compression or unloading. This is performed so that during a rotation about the rotation axis due to a displacement of the receiver surface of the energy accumulator by a specified rotation angle, the connection point also preferably rotates by the same rotation angle in the circular segment shaped recess. Additionally, it can be provided that the support element comprises an additional connection point at the respectively adjusted connection point, or in case of an embodiment with two components, radially between the connection point and the support surface for the associated energy accumulator.

The at least one support element can be supported on the component of the torsion vibration damper, so that a rotation is optimized with respect to friction, for example, a straight bearing or a roller bearing can operate between the circular segment shaped recesses and the at least one support element. In a similar manner, the pivotable support can be supported in a straight bearing or in roller bearing, radially between the connection point and the outer support surface for the energy accumulator(s).

The support elements distributed about the circumference can be spoke units, distributed about the circumference, wherein the support surface of the spoke units is adapted to the geometric configuration of the energy accumulator(s). Thus, e.g. in a support element or in a spoke unit, which receives or supports two adjacent short coil springs, a wedge-shaped support surface for supporting the face side spring ends of the two adjacent coil springs can be provided with a radially outward expanding wedge, which additionally comprises supports in circumferential direction on the radial outside against the effects of centrifugal forces. Another embodiment with support surfaces for coil- or arc springs in the portion distal from their ends can be in particular on the radial outside a radially inward oriented profile, which reconfigures at least one winding, or the free cavity formed between two windings, so that a sliding or displacement of the spoke unit relative to the spring can be avoided in an advantageous manner. Furthermore, an elastic component, e.g. a spring shoe, e.g. made of plastic or metal, can be provided between the spoke unit and the support surface of the energy accumulator.

In a particular embodiment, the support elements can be configured as spoke units, wherein these are received at a flange rotatable relative to the rotation axis. The flange in turn is supported and possibly centered on a component of the torsion vibration damper. The component can be the input component or the output component or a lug receiving both of them. Thus, when the energy accumulator is rotated, the flange rotates by the same angle relative to the component receiving it. In order to absorb differences in the rotation angle, at least some of the spoke units can be configured rotatable relative to the flange. The flange can be supported on the component in a straight bearing and can be secured axially.

The torsion vibration damper can be used in a torque converter in an advantageous embodiment. For this purpose, the input component of the torsion vibration damper can be coupled to an input component of a torque converter, e.g. to the converter housing, or in case of an existing converter lockup clutch, to the output component of the converter lockup clutch, and the output component of the torsion vibration damper can be operatively coupled in rotation direction to a turbine of the torque converter. By operatively connected or operatively coupled is meant that a component or device is connected either directly or indirectly to a second component and causes that second component to function. In a particular embodiment, the torsion vibration damper can be connected between the converter housing and the converter lockup clutch. An arrangement of the torsion vibration damper can also be performed according to the arrangement of a dual mass flywheel between crankshaft and converter housing outside of the torque converter.

The same or an additional torsion vibration damper can be provided as so-called turbine damper between turbine and transmission input shaft by connecting e.g. an input component of the torsion vibration damper to the turbine, and operatively connecting an output component of the torsion vibration damper to an output component of the torque converter in rotation direction. For example, the output component can be connected through a teething to the transmission input shaft and the input component can be connected through a teething to a turbine hub.

In another advantageous embodiment as a clutch disk in a friction clutch or as a dual mass flywheel, the input component can be connected to a crankshaft or to a flywheel, and the output component can be connectable to a transmission input shaft. When using the torsion vibration damper in a dual mass flywheel, the input and the output components each carry a mass with a predetermined mass moment of inertia, and the output component forms the secondary component, at which a friction clutch can be disposed, while the input component forms the primary component, which is connected to the crankshaft of the combustion engine. It is appreciated that the torsion vibration damper can also be used for other application geometries with the same advantages.

The invention is furthermore implemented by a hydrodynamic torque converter, comprising a pump shell, connected to a housing, and by a turbine shell, which can be bridged by a converter lockup clutch, wherein at least one energy accumulator is supported by at least one support element against centrifugal force effects, wherein the at least one support element is rotatable within limits radially inside of the at least one energy accumulator at a component of the torsion vibration damper about its rotation axis. The component can be an input component, an output component, a hub or a comparable component of the torsion vibration damper.

### BRIEF DESCRIPTION OF THE SEVERAL VIEWS OF THE DRAWINGS

The invention is now described with reference to the FIGS. 1-10, showing in:

FIG. 1 a sectional view of an embodiment of a torsion vibration damper;

FIG. 2 a sectional view of the torsion vibration damper of FIG. 1 with a changed section line;

FIG. 3 a view of a flange comprising support elements of the torsion vibration damper of FIGS. 1 and 2;

FIG. 4 a longitudinal sectional view of a torsion vibration damper modified with respect to FIGS. 1-3;

FIG. 5 an embodiment of a spring shoe for a support element of the FIGS. 1-4;

FIGS. 6 and 7 a sectional view of a support element in two actuation positions;

FIG. 8 a partial view of an alternative embodiment of a torsion vibration damper;

FIG. 9 a partial view of another embodiment of a torsion vibration damper; and

FIG. 10 a partial view of an embodiment of a torsion vibration damper comprising several short coil springs.

### DETAILED DESCRIPTION OF PREFERRED EMBODIMENTS OF THE INVENTION

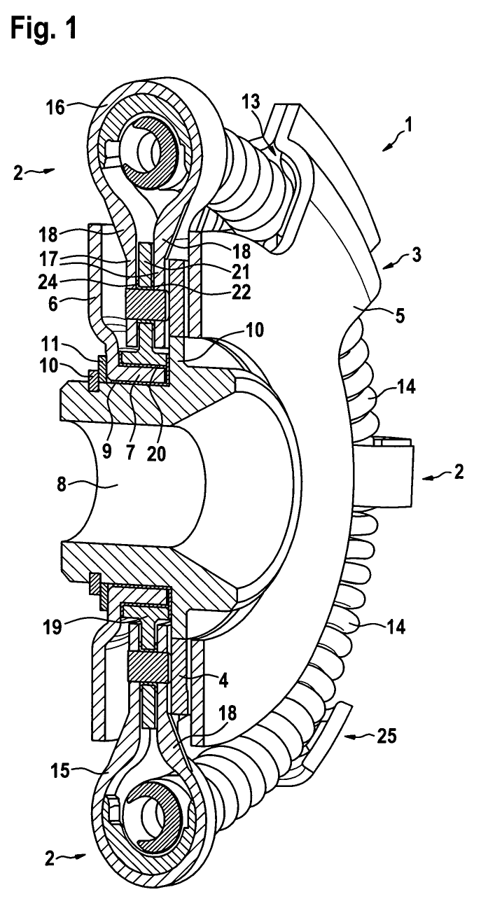

FIG. 1 shows an embodiment of a torsion vibration damper 1, cut along a support element 2. The torsion vibration damper 1 is comprised of disk shaped flange components, which can be produced by a metal forming process, preferably in one step, and which form an input component 3 and an output component 4. The input component 3 thus forms the axial outsides of the torsion vibration damper 1 with the two disk components 5, 6. The two disk components 5, 6 interlock with a driving component of the drive train at a location, which is not shown. The disk component 6 can e.g. comprise a teething, a rivet joint or similar with an output component of a torque converter lockup clutch of a hydrodynamic torque converter or with another converter component. The disk component 6 comprises an axially formed shoulder 7 at its radial inner end, in which the shoulder is formed as a support surface for the supported and centered reception of the disk component 6 on a hub 8, which can be produced as a stamped- or pressed component, sintered or forged or partially hardened. Between the axial shoulder 7 and the hub 8, a straight bearing 9 with a radial shoulder 10 is provided, so that in case of a contact of the shoulder 7 at a shoulder 10, which is offset in an annular manner to the radial outside, a relative rotation between the disk component 6 and the hub 8 can be performed with reduced friction. The disk component 6 is placed onto the hub 8 together with the straight bearing 9 during assembly, and axially secured by means of the safety disk 11. In order to adjust a defined friction between the disk component 6 and the hub 8, a friction ring 12 can be provided.

The disk component 6 is preferably connected on the radial outside to the disk component 5 for forming the input component 3, e.g. welded or riveted. The input component 3 loads the two arc springs 14 by means of the loading devices 13, wherein the arc springs are also loaded by the output component 4, and thus compressed during a relative rotation of the input component 3 and output component 4. The output component 4 is received torque proof e.g. welded, riveted, shrunk or connected in a similar manner at the annular collar 10 of the hub 8, wherein the collar is produced e.g. by a transversal flow press process. The torque transferred into the torsion vibration damper 1 through the input component 3 is transferred through the arc springs 14 onto the output component 4, and thus onto the hub 8, which can transfer the torque through an inner teething, which is not shown, onto a transmission input component, e.g. to a transmission input shaft. In the same way, the input- and output component 3 and 4 can be interchanged, whereby e.g. the hub 8 can be provided as a receiver at a crankshaft, and the disk component 5 can comprise a press plate and receiver elements for a friction clutch. In consideration of respectively necessary masses at the input- and output component 3, 4, thus a dual mass flywheel can be configured. It is appreciated, that other changes of the torsion vibration damper 1 can also be performed, in order to form an object comprising the advantageous support elements.

The support elements 2 are formed by one spoke unit 15 each, which are preferably formed from sheet metal and bent and which reach around the arc springs 14 in radial direction in hook-in element 16. In order to stabilize the spoke units 15, in particular in the transition portion of the hook-in element, substantially following the arc spring 14 and in the portion of the flat ears on both sides, in particular a chord 18 can be provided at least at one side. The two ears are connected to a flange component 19, which is supported in a straight bearing 20 on the shoulder 7, and centered. It is appreciated, that at least one of the two straight bearings 7, 20 can also be replaced by roller bearing, e.g. by a needle bearing. The flange component 19 can furthermore be directly supported on the hub 8. Thus, the disk component 6 can be supported on the flange component, or can also be supported axially next to it on the hub 8. The two ears 17 enclose the annular shoulder 21 provided at the flange component 19 in a rotatable fixation, so that the shoulder 21 can also be replaced by particular radially aligned ring segments, provided at the flange component 19 in the portion of the receiver of the ear 17. For this purpose, the ears 17 are riveted together with the annular shoulder 21. In order to reduce friction and/or wear, a bearing bushing 22, which preferably comprises annular shoulders 24 along the flange component on both sides, wherein said shoulders are disposed as spacers, and/or for reducing the friction between the flange component 21 and the ears 17, can be provided from softer material than the flange component 19 for receiving rivets 23, bolts or pins. In an advantageous manner, headless fasteners like rivets 23 are being used in order to optimize the axial installation space.

The torsion vibration damper comprises additional support elements 25 in the illustrated embodiment, which are approximately offset by 90°, relative to the support elements 2, such that the support elements 25 only partially reach over the arc springs. They are formed from radially extending arms and they are worked on the radial outside following the radius of the cross section of the arc springs 14. For example, they may be rolled. The support elements can preferably be integrally connected to the disk component 6, the output component 4 and/or the flange component 19, wherein they are respectively run by in the portion of the inner diameter and by the other disk or flange components through respective kinking or forming.

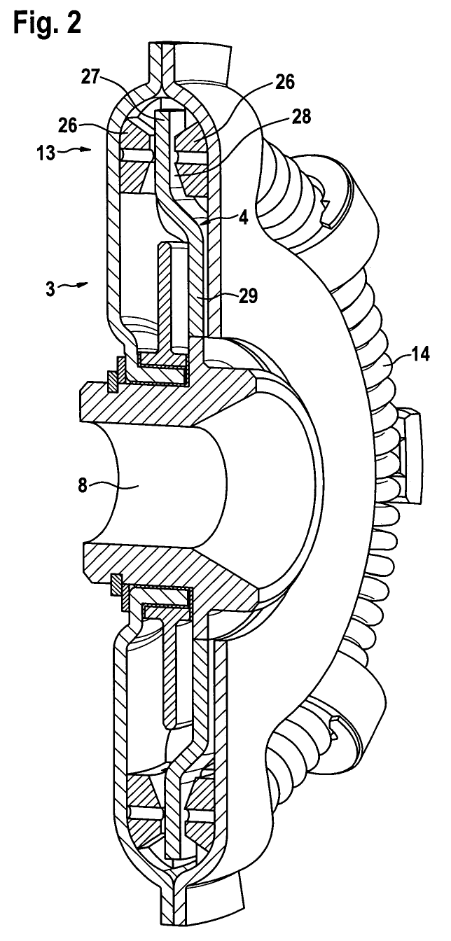

FIG. 2 shows the torsion vibration damper of FIG. 1 with a revised cutline along the loading devices 13. For loading the face sides of the arc springs 14, at least one respective loading surface 26, 27 is provided at the input component 3 and at the output component 4. Both loading surfaces 26 associated with the input component 3 are respectively disposed opposite to one another at the disk components 5, 6, and are mounted on them in the form of blocks forming the loading surfaces 26, e.g. welded, riveted or bolted. Alternatively, the disk components 5, 6 can comprise respective pocket shaped embossings, also forming stop surfaces or stop edges at their edges, which interact with the front faces of the arc springs. In order to form the loading surface 27 of the output component, the flange 29 connected to the hub 8 is provided with radially extending arms 28, which are axially attached based on a axially non-centered position of the flange 29 on the hub, so that they can be run to the radial outside, axially between the two loading surfaces 26, and so that they load the front faces of the arc springs 14 at the same radial position, wherein the extension of the arms 28 in circumferential direction is the extension of the blocks forming the loading surfaces 26. Since the front faces of the arc springs 14 follow a cutline through the rotation axis, the arms 28 can be wider in the portion of the loading surface 27 on the radial outside, than on the radial inside, so that they contact the front faces of the arc springs flush with their entire frontal contact surface.

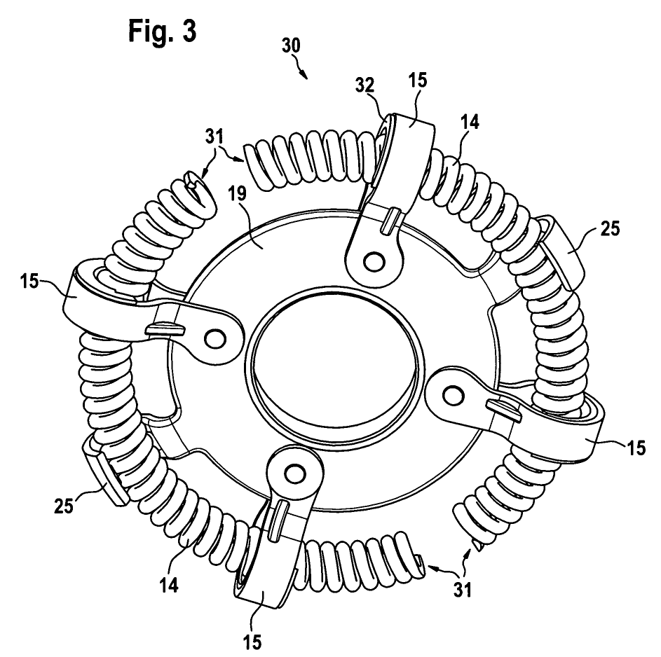

FIG. 3 shows a possible embodiment of a flange component 19 from the FIGS. 1 and 2 as a partial assembly of the torsion vibration damper 1 (FIGS. 1 and 2). The flange component 19 receives the two arc springs 14 through the spoke units 15, so they cannot be lost. The spoke units 15 are rotatably connected to the flange component 19, additionally further support elements 25 are provided substantially at an angle of 90° to the loading devices 13 (FIGS. 1 and 2) for loading the front faces 31 of the arc springs 14, wherein the support elements 25 radially support the arc springs during operation in addition to the spoke units 15. As arms or extension arms, they are integrally connected to the flange component 19 and placed around the arc springs 14 on the radial outside. Alternatively, the support elements 25 can also be formed from spoke units, which are connected to the flange component rotatable or non-rotatable, in order to be able to reduce production cost by a smaller round material diameter, when producing the flange component 19 as a stamped part. The spoke units 15 and the support elements 25 can comprise different types of guides of the arc springs 14. Thus, it can be provided, that the spoke units 15 operatively engage the arc springs 14 in circumferential direction, while the support elements 25 only provide a radial support under the effect of centrifugal force. It is appreciated, that the guides can be configured differently, depending on the type of the embodiment. For operative engagement in circumferential direction, the spoke units 15 can comprise respective embossings or inner profiles, which engage the gaps between the windings of the arc springs 14, radially over at least a portion of the circumference of the windings. The so-called spring shoes 32 have proven to be advantageous in particular, which are preferably inserted during assembly under a preload after the arc springs 14 have been inserted through the spoke units 15, so that the assembly can be facilitated. It is appreciated, that the support elements illustrated in FIGS. 1-3, which reach around the arc springs, can also be configured in a manner, so that they are hooked into one or several windings from the radial inside. This way, the radial installation volume of a torsion vibration damper can be reduced, or higher spring constants can be used with the same diameter, since the springs can be positioned radially further outside. This also applies for short coil springs, which are used instead of the arc springs, wherein e.g. several springs are arranged in series, and wherein preferably the frontal ends are supported.

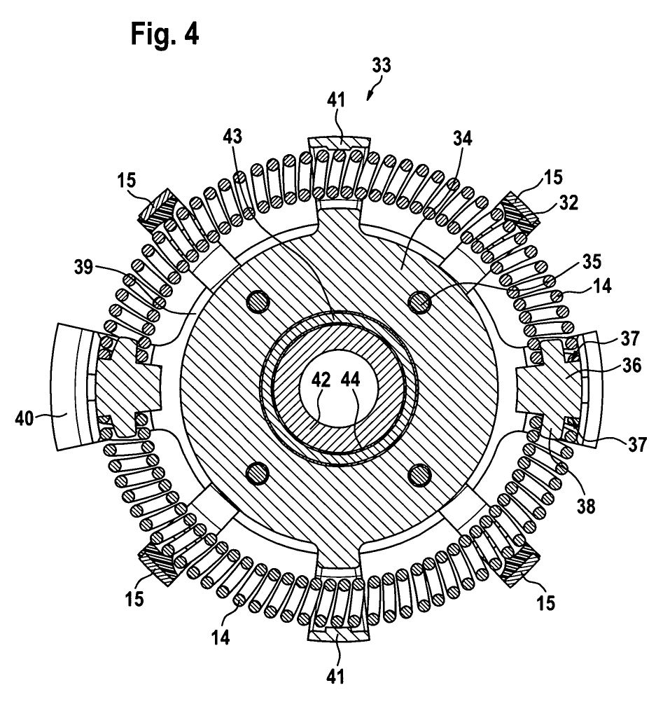

FIG. 4 illustrates an embodiment of a torsion vibration damper 33 in a longitudinal cut view, which has been modified with respect to the embodiment shown in FIGS. 1-3. The difference is that the output component 4 (FIG. 1) and the flange component 19 (FIG. 1) carrying the support elements 2 are integrated. Thus, the output component 34 carries the spoke units 15 with spring shoes 32, which can be rotated by means of the rivets 35, relative to the output component 34, and the output loading devices provided as extending arms 36, which load the front faces of the arc springs 14 with their circumferential loading surfaces 37. In order to better guide the loading surfaces 37 relative to the arc springs 14, said loading surfaces 37 can comprise protrusions 38, engaging the inner spring diameters in circumferential direction. The output component 34 is axially enclosed by the disk portions forming the input component. Of the disk portions, only the disk portion 39 with a portion of the radially outward extending input side loading devices 40 is illustrated. Furthermore, the output component 31 includes radially extending support elements 41, which are integrally connected to the output component 34, and which are rolled around the arc springs 14 on the radial outside.

The input component 39 is rotatable in the illustrated embodiment by means of an axial shoulder 43, and centered on the hub 42, and possibly received on said hub with a bearing, like e.g. a straight bearing 44 or a roller bearing in between. The output component is centered on the shoulder 43 with a bearing 45 placed in between and received rotatable. The form locking between the hub 42 and the input or output component is typically performed by means of a teething or a connection which is not shown.

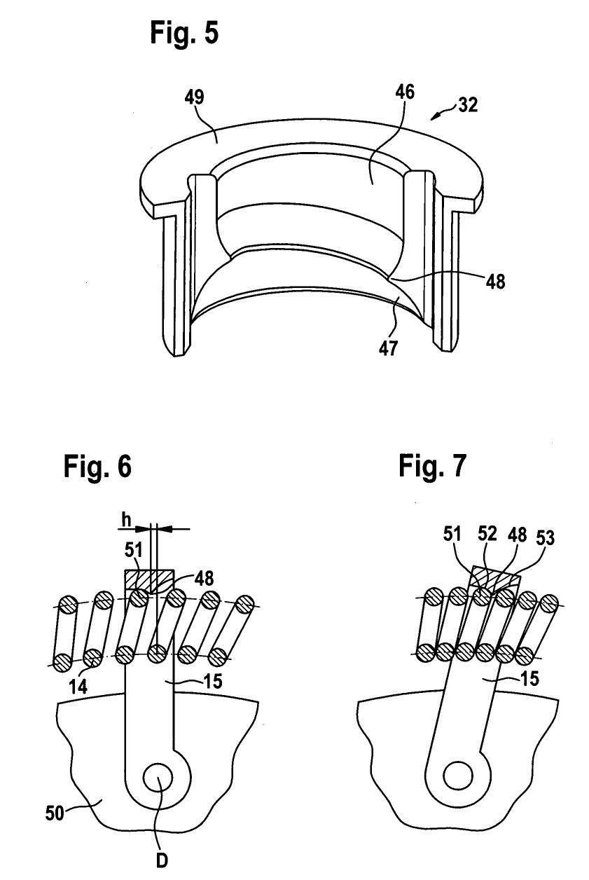

FIG. 5 illustrates an advantageous embodiment of a spring shoe 32, as it can be used e.g. in the FIGS. 1-4. The spring shoe 32 is configured in the shape of a bolt segment, comprising an annular shoulder 49 as a stop in the spoke unit. The direction of the insertion of the spring shoe results from the direction of the main force. The spring shoe 32 comprises two steps 46, 47, which are separated from one another through a portion of a thread winding 48. Thus, it can be quasi threaded into the spoke unit during assembly. The thread winding 48 thus has the pitch of the windings of the arc springs under blockage loading at the location where the support element is disposed, so that it radially engages into an intermediary space formed by two windings. In this manner, an interlock between the blockage loaded spring and the spring shoe is created, and thus an interlock between the arc spring and the support element. The spring shoe is advantageously inserted into the spoke unit, when the arc spring is inserted through the spoke unit, but the spoke unit is not yet riveted to the flange component.

FIG. 6 shows an advantageous embodiment of the thread winding 48 at a cut spoke unit 15 with the arc spring 14 already inserted. For an advantageous impact of the thread winding 48 onto the adjacent winding of the arc spring 14, the thread winding is moved relative to the point of rotation D of the spoke unit 15 relative to a flange component 50 by the amount h against the contact surface of the winding, this means the point of rotation D is offset relative to the contact point between winding 51 and thread winding 48 by the distance h from the contact point.

It is apparent from FIG. 7, that when rotating the spoke unit 15 about the rotation point d, under load, the thread winding 48 advantageously comprises two different radii. At the thread surface 52, facing the force direction, the radius preferably corresponds to the outer radius of the winding 51, while the radius at the thread surface 53 facing away from the force results from the occurring rotation of the spoke unit 15 with a resultant tilting of the winding 54 adjacent to the winding 51.

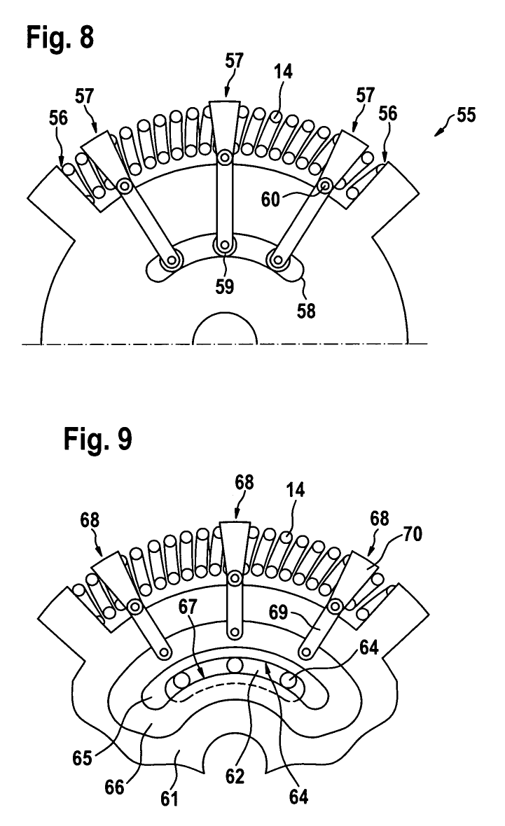

FIG. 8 shows a detail sketch of a flange component 55 with an arc spring 14 inserted between two loading surfaces 56, wherein the arc spring 14 is radially supported by support elements 57 against the effects of centrifugal forces. Different from the support elements described in the previous figures, the support elements 57 described in FIG. 8 are supported at a circular segment shaped opening 58, which is provided in the flange component e.g. punched out, pressed out or milled out. The radius of the circular segment shaped opening 58 has its center in the rotation axis of the flange component 55. When compressing the arc springs 14 by rotating the flange component 55 relative to another flange component, also loading the arc springs 14, the support elements 57 displace with the movement of the windings of the arc spring 14, at which they engage the arc spring 14, by a similar angle in the opening 58, so that substantially no relative movement occurs between the support elements and the windings. The support elements 57 can engage the gaps of the windings, or they can engage the windings through connectors like clip connectors. In order to reduce friction, a support like a straight bearing or a roller bearing 59 can be provided at the receivers of the support devices 57 in the opening 58, preferably towards the radial outer wall of the opening 58. For adapting rotation angles, the support elements can comprise another joint 60.

FIG. 9 shows a detail of a torsion vibration damper with a flange component 61 similar to the flange component 55 of FIG. 8 with a circular segment type opening 62, in which loose rollers 63 roll along a track 64, which is formed by the opening 62, when the flange component 61 is rotated against the effect of the arc springs 14 against another flange component, which is not illustrated, wherein both flange components load the arc springs 14 at their face sides, in order to impart a compressing effect on the arc springs 14. The rollers 63 thus do not roll on the track 64 of the opening 62, but axially reach through a second circular segment shaped opening 65, provided in a bar 66 disposed at the flange component, wherein said opening has a second track 67, whose inner radial track 67 has the same radius as the radial outer track 64 of the opening 62. At the bar 66, one or plural, e.g. as shown, three support elements 68 with a spoke 69 and with a hook-in element 70, radially reaching around the arc springs 14, wherein said hook elements 70 can be fixated to the spoke 69 or can be pivotably connected thereto, are received in a fixated manner or in a pivotable manner as shown. The rollers 64 can comprise annular shoulders at their axial ends, by means of which the bar 66 is received on the flange component 61, rotatable and secured against fallout in axial direction. The extension of the openings 62, 65 is adjusted to the maximum angle of rotation, so that the rollers 64 in a preferred manner at maximum rotation of the two flange components do not contact the circumferential walls of the openings 62, 65, but the limitation is effected in another manner, e.g. through hard or elastic stops or through the arc springs 14 going into blockage. The rollers 64 can be offset relative to one another by means of cage shaped spacers in circumferential direction.

Through the illustrated embodiment of the flange component 61 with the bar 66, cinematically linked by the rollers 64, a displacement of the support elements 68 relative to the flange component in the same direction and with low friction is performed when the flange component 61 is rotated relative to the other flange component. Possibly remaining tensions between the support elements when the arc springs 14 are compressed can be at least partially reduced by the linked disposition of the spokes 69, on the one hand, relative to the bar 66, and, on the other hand, relative to the hookup elements 70.

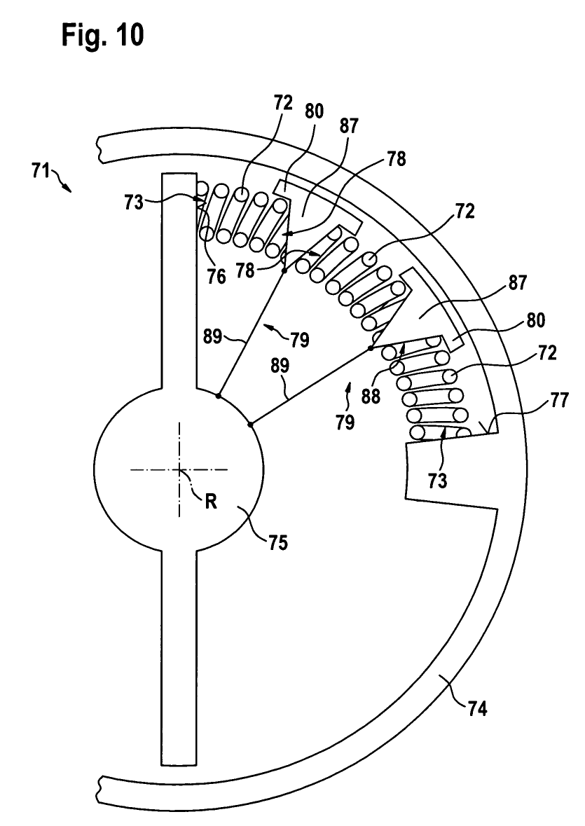

FIG. 10 shows a detail sketch of a solution similar to the embodiments of FIGS. 8 and 9 of a torsion vibration damper 71, which is similar to the embodiments of FIGS. 8 and 9, with several short coil springs 72 instead of the arc springs used therein, wherein the coil springs 72 are assembled in a group by putting plural, for example three, short coil springs 72 in series behind one another, and by clamping the front face 73 of the ends of the group of springs between a first a flange component 74 and a second flange component 75. The two flange components 74, 75 thus form an input- and an output component of the torsion vibration damper 71. In the illustrated embodiment, the stop surfaces 76, 77 for the front faces 73 of the coil springs 72 are offset relative to one another by an angle. In other embodiments, this offset can also be removed according to the arrangement in FIG. 2.

In order to stabilize the transitions of the front faces 78 within the group of springs, support elements 79 are provided, which are supported at one of the flange components, or at one hub radially within the coil springs. In the illustrated embodiment, these coil springs are hooked up in a similar manner, as the support elements 57 of FIG. 8. Solutions according to the other preceding figures can also be advantageous for short coil springs 72 combined into a group of springs.

The support elements 72 are particular because they are expanded radially in circumferential direction for supporting the front faces 78. Respective extensions 80 are provided for said purpose, which can already be provided during stamping, when producing the hookup elements 87 from sheet metal. The hookup elements can be configured so that they form an intermediary component for forming an elastic or inelastic buffer between the front faces 78 of the coil springs 72, or so that they bring the face sides of the adjacent coil springs into direct contact with one another (not shown). They can furthermore form contact surfaces 88, which are disposed opposite at a slant angle with respect to a section line along the respective support element 79, leading through the point of rotation D of the torsion vibration damper 71. Hereby, the coil springs 72 can be disposed at an arc, while evenly loading their front faces 78.

The hookup of the spokes 89 in the flange component 75 is performed rotatable about the rotation axis, and optionally rotatable about the rotation axis of the hookup. Furthermore, spokes 89 and hookup elements 87 can be linked together, like in the embodiments previously shown. It is appreciated, that the stop surface 76 shown in a sketch can also comprise a safety against a deflection of the coil springs 72 to the radial outside.

### DESIGNATIONS

1 torsion vibration damper
2 support element
3 input component
4 output component
5 disk portion
6 disk portion
7 shoulder
8 hub
9 straight bearing
10 shoulder
11 safety disk
12 friction ring
13 loading direction
14 arc spring
15 spoke unit
16 hookup element
17 ear
18 cord
19 flange component
20 straight bearing
21 annular shoulder
22 support bushing
23 rivet
24 annular shoulder
25 support element
26 loading surface
27 loading surface
28 arm
29 flange
30 partial assembly
31 front face
32 spring shoe
33 partial assembly
34 output component
35 rivet
36 arm
37 loading surface
38 shoulder
39 disk component
40 loading direction
41 support element
42 hub
43 shoulder
44 straight bearing
45 bearing
46 step
47 step
48 thread winding
49 shoulder
50 flange component
51 winding
52 thread surface
53 thread surface
54 winding
55 flange component
56 loading surface
57 support element
58 opening
59 roller bearing
60 link
61 flange component
62 opening
63 roller
64 track
65 opening
66 track
67 bar
68 support element
69 spoke
70 hookup element
71 torsion vibration damper
72 coil spring
73 front face
74 flange component
75 flange component
76 stop surface
77 stop surface
78 front face
79 support element
80 extension
87 hookup element
88 support surface
89 spoke
D point of rotation
R axis of rotation
h distance

What is claimed is:

1. A torsion vibration damper (1, 71) for a drive train, comprising two flange components, forming an input component (3) and an output component (4), rotatable within limits relative to one another about a common axis of rotation (R) against the effect of at least one energy accumulator, wherein the at least one energy accumulator is supported against centrifugal force effects by at least one support element (2, 25, 41, 57, 68, 79), which is supported radially inside the at least one energy accumulator, wherein the at least one support element (2, 25, 41, 57, 68, 79) is supported rotatable about a rotation axis (R) relative to the flange components.

2. A torsion vibration damper (1) according to claim 1, wherein the at least one energy accumulator is formed from at least two arc springs (14) extending about the circumference.

3. A torsion vibration damper (71) according to claim 2, wherein the at least one energy accumulator is alternatively or additionally formed from at least three coil springs (72), distributed about the circumference on a diameter.

4. A torsion vibration damper (71) according to claim 1, wherein the at least one support element (57, 68, 79) is received in a circular segment shaped opening (58, 62) in a component of the torsion vibration damper (71).

5. A torsion vibration damper (1) according to claim 1, wherein the at least one support element (2) is supported in a straight bearing on a component of the torsion vibration damper (1).

6. A torsion vibration damper (1) according to claim 1, wherein at least one disk component (5, 6, 39) forming an input component (3) or an output component, and the at least one support element (2), are received rotatable about the rotation axis (R) on a hub (8).

7. A torsion vibration damper (1, 71) according to claim 1, wherein the at least one support element (2, 25, 41, 57, 68, 79) is formed from plural spoke units (15), distributed about the circumference.

8. A torsion vibration damper (1) according to claim 7, wherein at least a portion of the spoke units (15) is formed from a spoke (89) and from a hookup element (16, 70, 87).

9. A torsion vibration damper (1) according to claim 7, wherein the spoke units (15) are received on a flange (19), rotatable about a rotation axis (R) relative to a component of the torsion vibration damper (1).

10. A torsion vibration damper (1) according to claim 9, wherein at least a portion of the spoke units (15) is disposed rotatable relative to the flange (19).

11. A torsion vibration damper (1) according to claims 1, wherein the input component (3) is operatively engaged in rotation direction with an input component of a torque converter, and the output component (4) is operatively engaged in rotation direction with a turbine of the torque converter.

12. A torsion vibration damper according to claim 1, wherein the at least one support element simultaneously forms a load on the input component and/or of the output component for the at least one energy accumulator.

13. A torsion vibration damper according to claim 1, wherein the input component of the torsion vibration damper is operatively connected in rotation direction to a turbine, and an output component of a torsion vibration damper is operatively connected in rotation direction to an output component of a torque converter.

14. A torsion vibration damper according to claim 1, wherein the input component is connected to a crankshaft and the output component can be connected to a transmission input shaft.

15. A hydrodynamic torque converter comprising a pump shell connected to a housing, and comprising a turbine shell, which can be bridged by a converter lockup clutch, characterized by a torsion vibration damper according to claim 1.
